(19) United States
(12) Patent Application Publication
(10) Pub. No.: US 2017/0037652 A1
(43) Pub. Date: Feb. 9, 2017

(54) ANCHORING DEVICE

(71) Applicant: John DONADIO, Harrison, NY (US)

(72) Inventor: John DONADIO, Harrison, NY (US)

(21) Appl. No.: 15/228,433

(22) Filed: Aug. 4, 2016

Related U.S. Application Data
(60) Provisional application No. 62/200,701, filed on Aug. 4, 2015.

(51) Int. Cl. E04H 15/62; F16M 13/02; A47G 9/06

(52) U.S. Cl. CPC E04H 15/62; A47G 9/062; F16M 13/02

(57) ABSTRACT

An anchoring device for a blanket, towel or other sheet item comprises a hollow housing forming an inner chamber with a central portion and a plurality of arms extending outwardly therefrom. The chamber is adapted to accept and retain a flowable material, such as sand. The device may include a closable opening to allow the chamber to be filled with the flowable material and for the flowable material to be emptied from the chamber.

The present invention relates to an anchoring device, and in particular to an anchoring device for retaining a towel, blanket or the like on the ground.

### BACKGROUND OF THE INVENTION

Blankets, towels and the like (“sheet objects”) are often placed on the ground to provide a sitting or resting surface. Beach blankets and towels, in particular, are used on the beach to provide a smooth, essentially sand-free surface on which to sit or lie. However, the presence of wind often prevents the blanket or towel from remaining very long in the initial, spread-open position. In addition, the motions of those on the blanket, sometimes aided by a breeze or wind gust, may cause undesired shifts in the blanket's position. In is distracting and annoying to continuously reposition and unfurl a blanket that has been whipped by the wind.

It is known to apply weights to the margins of the blanket or towel to maintain its position on the ground. Since the weight of the mass of the weighting object typically provides the desired stabilizing force, it is inconvenient to carry such stabilizing objects to and from the desired location for the blanket or towel. Both their mass and size make such devices unattractive to many.

Other devices to stabilize a beach blanket or towel rely on a stake or rod which is hammered into the ground to provide a stable connection point. The blanket or towel is then connected to the stake with some form of connector or clip. The size of the stake needed to provide effective holding power can make the device awkward to transport. In addition the need to force the stake into the ground often requires an auxiliary tool, such as a hammer, which itself must be transported by the user.

It is accordingly a purpose of the present invention to provide a device for anchoring or stabilizing a blanket, towel or similar object on the ground that avoids the shortcoming of the prior art.

### BRIEF SUMMARY OF THE INVENTION

The present invention comprises a flexible pouch construction device which may be transported to and from a desired location empty. The device, which is provided with a sealable opening, is constructed to be filled with material, such as sand, found at the use location, to provide sufficient mass to the construction to stabilize and retain a blanket, towel or the like when the filled device is placed at a location thereon. Typically, a series of the devices will be placed about the periphery of the blanket or the like.

The device is constructed with a series of outwardly-extending arms or projections from a central portion. The arms allow the device to be positioned at a corner of the towel or blanket, with two of the arms lying about the general local periphery of the towel to apply the desired retaining force to edges of the blanket while minimizing the surface area of the blanket covered by the device.

### BRIEF DESCRIPTION OF THE DRAWINGS

FIG. 1 is a top plan view of the invention;

FIG. 2 is an elevation view thereof, depicting the fill port;

FIG. 3 depicts the invention in place on a towel or the like; and

FIG. 4 depicts a top plan view of a decorated device.

### DETAILED DESCRIPTION OF THE INVENTION

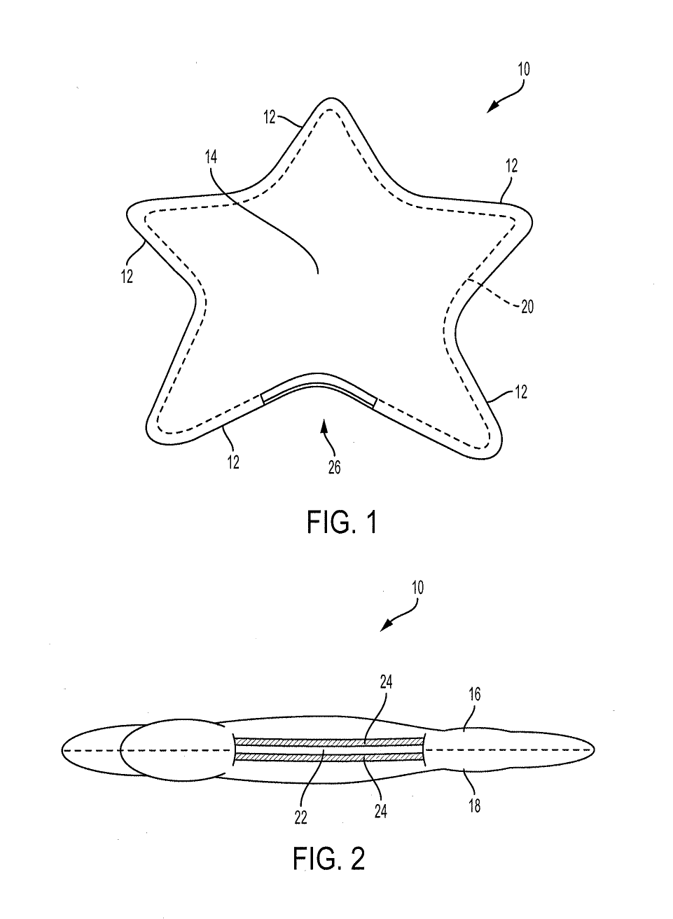

As shown in FIGS. 1 and 2, anchoring device 10, which may be constructed of a tough, pliable, durable, and preferably waterproof, material. A preferred material is neoprene, but other plastic or rubber materials, as well as fabrics, may be used. The device may be in the form in plan of a generally star-shape, with a series of arms 12 projecting outwardly from central portion 14. A preferred number of arms is five. Aligned and identically shaped top and bottom pieces 16, 18, may be fastened together about their common peripheries to provide an inner chamber or pouch extending from the central portion 14 into each of the arms 12. The top and bottom pieces may be joined together along line 20 by heat sealing, gluing, or stitching as known in the art. The arms may circumscribe a circle approximately 4.5 inches in diameter.

To allow the pouch to be filled with a weighting material, such as sand, the peripheral stitching 20 may be leave an entrance slot 22 between the top and bottom pieces. The opposing edges of the slot may be provided with complementary hook-and-loop elements 24 to allow the slot to be selectively opened for filling or emptying the chamber, and closed to retain the weighing material when desired. Other closures, such as a zipper, may alternatively be employed. The slot may be advantageously located at the intersection of two adjacent arms and the central portion at a location 26.

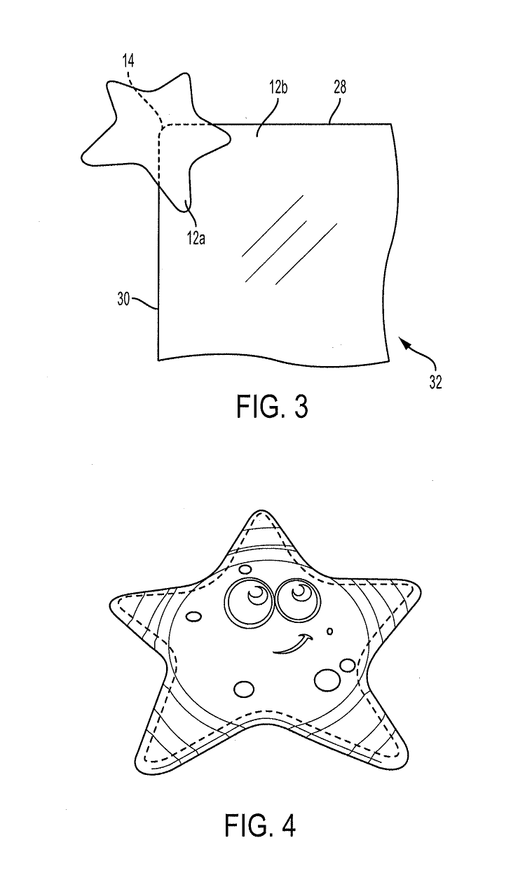

The anchoring device will typically be transported to the desired location for anchoring a blanket or towel in the unfilled configuration, allowing the device to be easily stowed and carried. At the desired location the entrance slot 22 is opened and the chamber filled with a weighting material, preferably sand. The slot is then closed to seal the weighting material inside the chamber. With the blanket or towel opened and placed in position, the anchoring devices are deployed as shown in FIG. 3. In particular, they may be advantageously place on the corners of the blanket or towel 26, with a pair of adjacent arms 12a, b being positioned generally along the corner between abutting edges 28, 30 of the blanket, with the central portion 14 of the device overlying the corner. The other arms of the device may lie upon the ground surface.

In such an orientation the arms 12a and 12b in conjunction with the central portion 14 provide retaining weight to the blanket without overly intruding upon the surface area of the blanket, while the overall weight of the device further insures that the device, and thus the retained blanket corner, stays in place. While one anchoring device will normally be placed at each corner of the blanket, additional devices may be placed along the edges of the blanket to provide additional holding power. When use of the devices is finished, the entrance slot 22 may be opened and the weighting contents empties. The device may then be stowed for subsequent reuse. To increase the attractiveness of the device, the surfaces may be adorned with an embossed or printed design, such as depicted in FIG. 4.

I claim:

1. An anchoring device, comprising a hollow housing forming an inner chamber with a central portion and a plurality of arms extending outwardly therefrom, the chamber being adapted to accept and retain a flowable material.

2. The anchoring device of claim 1 wherein the housing has a sealable aperture for accepting and removing the flowable material.

3. The anchoring device of claim 2 wherein the sealable aperture is located at the juncture of two adjacent arms.

4. The anchoring device of claim 1 wherein the arms are five in number.

5. The anchoring device of claim 2 wherein the arms are five in number.

6. The anchoring device of claim 2 wherein the housing if constructed of a top layer and a lower layer joined together about respective peripheries.

7. The anchoring device of claim 6 wherein the housing is constructed of a waterproof material.

8. The anchoring device of claim 7 wherein the material is neoprene.

9. An anchoring device comprising a hollow housing forming an inner chamber and having a central portion and a plurality of arms extending outwardly therefrom the chamber, and a flowable material located within the chamber.

10. The anchoring device of claim 9 wherein the flowable material is sand.

11. A method for anchoring the edges of a sheet object with the anchoring device of claim 1, comprising the steps of:
transporting the device and sheet object to a desired location;
positioning the sheet object on the surface;
filling the chamber of the device with the flowable material; and
positioning the device at a corner of the sheet object such that at least one of the arms lies upon the blanket and one of the arms lies directly upon the surface.

12. The method of claim 11, further comprising the steps of:
removing the device from its location on the sheet object;
emptying the chamber of the flowable material; and
stowing the sheet object and emptied device for further use.

13. The method of claim 12 wherein the anchoring device has 5 arms and the step of positioning the device at a corner of the sheet object comprises placing two of the arms on the sheet object.
